(19) United States
(12) Patent Application Publication
(10) Pub. No.: US 2004/0263122 A1
(43) Pub. Date: Dec. 30, 2004

(54) Electronic apparatus and power control method

(75) Inventor: Toshikazu Morisawa, Tokorozawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/821,992

(22) Filed: Apr. 12, 2004

(30) Foreign Application Priority Data
Jun. 30, 2003 (JP) 2003-188704

(51) Int. Cl. H02J 7/00

(52) U.S. Cl. 320/127

(57) ABSTRACT

An electronic apparatus includes a power management section configured to make power management based on setting information on which at least an AC power inhibit period for inhibiting use of AC power is set, a state determining section configured to determine whether there exists a plan to use the electronic apparatus by a battery drive when the electronic apparatus is connected with the AC power, and a power control section configured to execute battery charge using the AC power even if a current time is equivalent to the AC power inhibit period set in the power management section when the state determining section determines that there exists a plan to use the electronic apparatus by the battery drive.

### CROSS-REFERENCE TO RELATED APPLICATIONS

This application is based upon and claims the benefit of priority from prior Japanese Patent Application No. 2003-188704, filed Jun. 30, 2003, the entire contents of which are incorporated herein by reference.

### BACKGROUND OF THE INVENTION

1. Field of the Invention

The present invention relates to a battery-drivable electronic apparatus and a power control method and, more particularly, to an electronic apparatus capable of performing peak shift control.

2. Description of the Related Art

Recently, power management function referred to as peak shift control function has attracted special interest as a power management technique applied to electronic apparatuses such as personal computers (PCs). The peak shift control function means the power management function described below. According to the peak shift control, the power supply from an AC power supply is automatically stopped when power consumption peak time (particularly, daytime 13:00 p.m. to 16:00 p.m. in the summer) comes, and thereafter, a battery storing power is operated as a power supply. By doing so, leveling can be achieved in the load on power demand.

Various techniques have been proposed as the peak shift control. For example, Jpn. Pat. Appln. KOKAI Publication No. 2000-29576 discloses the technique of making a changeover from AC drive to battery drive when specified time comes during AC drive.

According to the foregoing technique, the AC driven is inhibited when specified time comes. If there occurs a situation (e.g., use in a conference) where the electronic apparatus is driven using battery as power source, the electronic apparatus is used in a state of low battery capacity. In this case, the available time of the electronic apparatus by the battery is reduced.

In order to solve the problem described above, users require taking the following matter into consideration. To be brief, the user must be conscious of starting battery charge by going back a predetermined time from the time when the situation of using battery as power source occurs, and furthermore, the user must preliminarily manipulate the electronic apparatus to invalidate peak shift control. However, this gives a heavy load to the user.

### BRIEF SUMMARY OF THE INVENTION

Embodiments of the present invention may provide an electronic apparatus and a power control method, capable of driving with sufficient battery capacity under the condition that a battery is used as power source without giving load to a user.

According to one aspect of the present invention, there is provided an electronic apparatus, comprising a power management section configured to make power management based on setting information on which at least an AC power inhibit period for inhibiting use of AC power is set; a state determining section configured to determine whether there exists a plan to use the electronic apparatus by a battery drive when the electronic apparatus is connected with the AC power; and a power control section configured to execute battery charge using the AC power even if a current time is equivalent to the AC power inhibit period set in the power management section when the state determining section determines that there exists a plan to use the electronic apparatus by the battery drive.

According to another aspect of the present invention, there is provided a power control method applied to an electronic apparatus, comprising making power management based on setting information on which at least an AC power inhibit period for inhibiting use of AC power is set; determining whether there exists a plan to use the electronic apparatus by a battery drive when the electronic apparatus is connected with the AC power; and executing battery charge using the AC power even if a current time is equivalent to the AC power inhibit period set in the power management when the determination indicates that there exists a plan to use the electronic apparatus by the battery drive.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an electronic apparatus according to one embodiment of the present invention;

FIG. 2 is a view showing the functional configuration to realize power control;

FIG. 3 is a view to explain peak shift control;

FIG. 4 is a view showing one example of the peak shift control;

FIG. 5 is a view showing one example of a setup screen for peak shift control;

FIG. 6 is a view showing one example of a schedule note managed by a schedule management application;

FIG. 7 is a flowchart showing power control based on the schedule note shown in FIG. 6;

FIG. 8 is a view showing a modification example of the schedule note shown in FIG. 6; and

FIG. 9 is a flowchart showing power control based on the schedule note shown in FIG. 8.

### DETAILED DESCRIPTION OF THE INVENTION

Embodiments of the present invention will be described below with reference to the drawings.

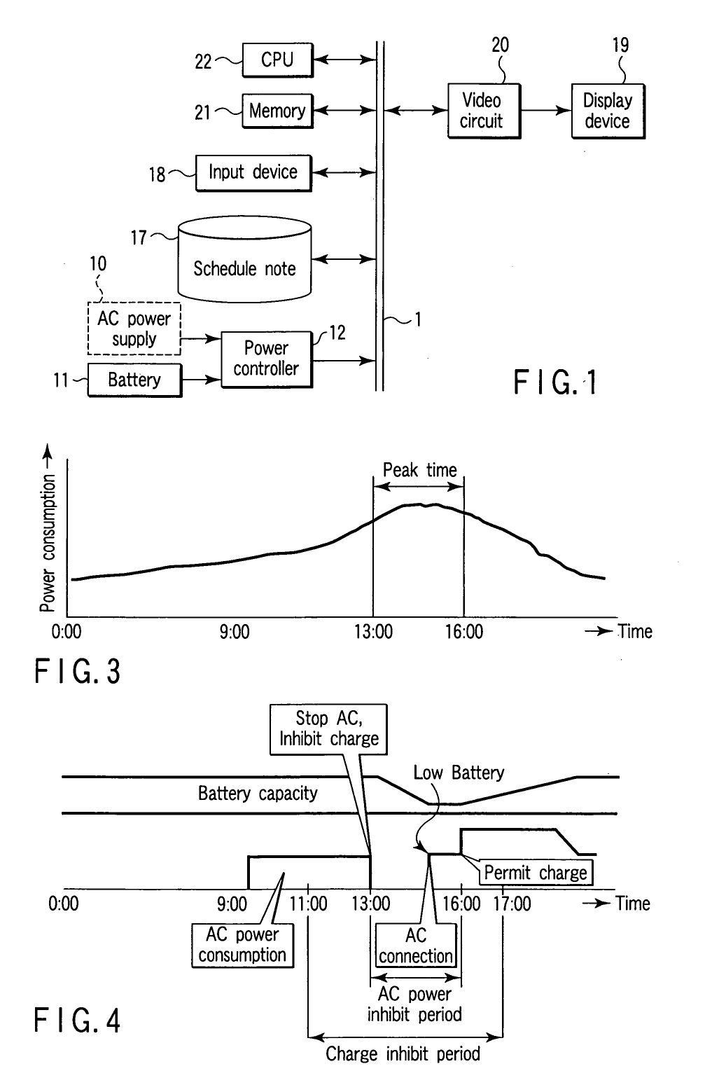

FIG. 1 is a block diagram showing the configuration of an electronic apparatus according to one embodiment of the present invention.

The electronic apparatus is a personal computer (PC), for example, and has several components as the power control target. The electronic apparatus includes bus 1, battery 11, power controller 12, storage medium 17, input device 18, display device 19, video circuit 20, memory 21, CPU 22, etc. In addition, the electronic apparatus is externally supplied with the power of an AC power (supply) 10 via commercial electric line and AC adapter.

The bus 1 connects various components constituting the electronic apparatus, and functions as the medium for making data exchange between these components.

The battery 11 is a rechargeable cell built in the electronic apparatus, and chargeable when the AC power 10 is supplied to the electronic apparatus.

The power controller 12 supplies necessary power to various components included in the electronic apparatus based on the power of the AC power 10 or battery 11.

The storage medium 17 is a hard disk drive, for example, and stores data of the schedule note (personal plan table). The data stored in the storage medium 17 is loaded onto the memory 21 as the need arises. In addition, the schedule note may be managed on the memory 21.

The input device 18 is equivalent to keyboard and mouse, and used for editing and setting data on a screen of the display device.

The display device 19 is an LCD (Liquid Crystal Display), and displays various setup screens and the schedule note (personal plan table) according to data supplied from the video circuit 20.

The video circuit 20 outputs data stored in the storage medium 17 and data inputted via the input device 18 to display device under the control by the CPU 22.

The memory 21 is a RAM (Random Access Memory) used as a work area of the CPU 22, and stores OS (operating system) executed by the CPU 22, various applications driver, data, etc.

The CPU 22 is a processor for controlling the whole operation of the electronic apparatus, and executes various programs.

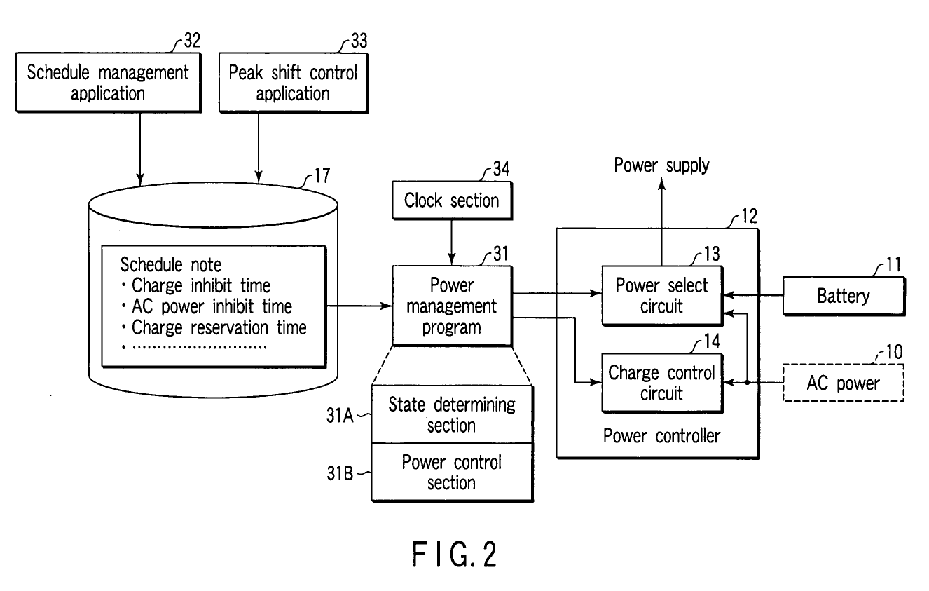

FIG. 2 is a view showing the functional configuration to realize power control of the present embodiment.

The power controller 12 shown in FIG. 2 is provided with a power select circuit 13 and a charge control circuit 14. The power select circuit 13 is a circuit, which selects power (i.e., AC power 10 or battery 11) to be used for the power supply to various components according to instructions from a power management program 31. The charge control circuit 14 is a circuit, which controls execution/stop of battery charge by the use of the AC power 10 according to instructions from the power management program 31

The power management program shown in FIG. 2, schedule management application 32 and peak shift control application 33 are stored in the memory 21, and executed by the CPU 22 in carrying out the power control. The schedule management application 32 and peak shift control application 33 may be built up in a manner that they are included in the power management program 31. A clock section 34 includes a timer used by the power management program 31.

The peak shift control application 33 is equivalent to a power management function referred to as peak shift control. In the peak shift control, the peak shift control application 33 is effective in only AC connection (connection to commercial electric line by AC adapter), and largely classified into the following three modes.

(A) AC power is used, and battery charge is carried out.

(B) AC power is used, but battery charge is not carried out (corresponding to “charge inhibit period”).

(C) Battery drive is carried out without using AC power (corresponding to “AC power inhibit period”).

More specifically, the peak shift control application 33 makes the power management based on information of setting the “AC power inhibit period” and information of setting the “charge inhibit period” for inhibiting battery charge.

A state determining section 31A makes the following determinations. One is a connection state of AC power (or AC adapter). Another is whether or not the current time is equivalent to the foregoing “AC power inhibit period” or “charge inhibit period”. Another is whether or not there exists a plan to carry out battery drive. In particular, the state deter-—-mining section 31A determines whether or not there exists a plan to use the electronic apparatus by battery drive when AC power is connected to the electronic apparatus. More specifically, the state determining section 31A calculates charge time spent for charging based on the difference between the maximum battery capacity and the battery capacity at the current time, and determines whether or not there exists a predetermined start point of using the electronic apparatus by battery drive until the charge time elapses from the current time. If there exist the start point, the state determining section 31A determines that there exists a plan to use battery drive. The charge time may be simply replaced with fixed time until the charge capacity shifts from residual charge 0% to full charge.

A power control section 31B carries out the corresponding power control based on the determination result of the state determining section 31A. In particular, the power control section 31B carries out the following control when the state determining section 31A determines that there exists a plan to use the electronic apparatus by battery drive. In this case, the power control section 31B carries out battery charge using AC power even if the current time is equivalent to the “AC power inhibit period” set in the peak shift control application 33. In addition, the power control section 31B carries out the following control when the state determining section 31A determines that there exists a plan to use the electronic apparatus by battery drive. In this case, the power control section 31B carries out battery charge using AC power even if the current time is equivalent to the “charge inhibit period” set in the peak shift control application 33.

The schedule management application 32 is equivalent to a schedule management function of managing the schedule note (personal plan table) used by the user on the storage medium 17 (or memory 21). The schedule management application 32 can register a period having a plan to use the electronic apparatus by battery drive in the schedule note together with the “AC power inhibit period”. In this case, the state determining section 31A makes the foregoing determinations based on the schedule note managed by the schedule management application 32.

In addition, the schedule management application 32 can register a “charge request period” requesting battery charge or “charge reservation time” to the schedule note in accordance with user's input operation. In this case, the state determining section 31A detects the “charge request period” registered in the schedule note managed by the schedule management application 32. Based on the detection, the state determining section 31A determines that there exists a plan to use the electronic apparatus by battery drive.

In accordance with user' request, the schedule management application 32 can display the schedule note on a screen of the display device 19 in a state that each period is classified using color-code.

The basic peak shift control will be explained below with reference to FIG. 3 and FIG. 4.

According to the peak shift control, when time comes to power consumption peak time zone (i.e., daytime 13 p.m. to 16 p.m. in summer) as seen from FIG. 3, the supply from AC power is automatically stopped. Thereafter, power management for operating the battery storing power thus far as power source is carried out.

For example, as shown in FIG. 4, the use of the AC power is inhibited from 13:00 p.m. in the peak shift control, and thereafter, battery charge by AC power is possible from 16:00 p.m. If the situation using the electric apparatus by battery drive occurs at the time of 15:00 p.m., the electronic apparatus is in a low battery state. As a result, the available time of the electronic apparatus by battery drive is reduced. For this reason, battery charge is required to started from half past 13:00 p.m. using AC power even if the time is “AC power inhibit period”.

In addition to the “AC power inhibit period”, a “charge inhibit period” (e.g., time from 11:00 am to 17:00 p.m.) may be set based on the agreement in a company or the like.

A setup screen for the peak shift control will be explained below with reference to FIG. 5.

As illustrated in FIG. 5, the screen is provided with an area 40 for setting the peak shift time. The area 40 has the following sub-areas 41 to 43. The sub-area 41 is used for setting a peak shift control period (month, day). The sub-area 42 is sued for setting a battery charge stop time zone (“charge inhibit period”). The sub-area 43 is used for setting a battery operation time zone (“AC power inhibit period”).

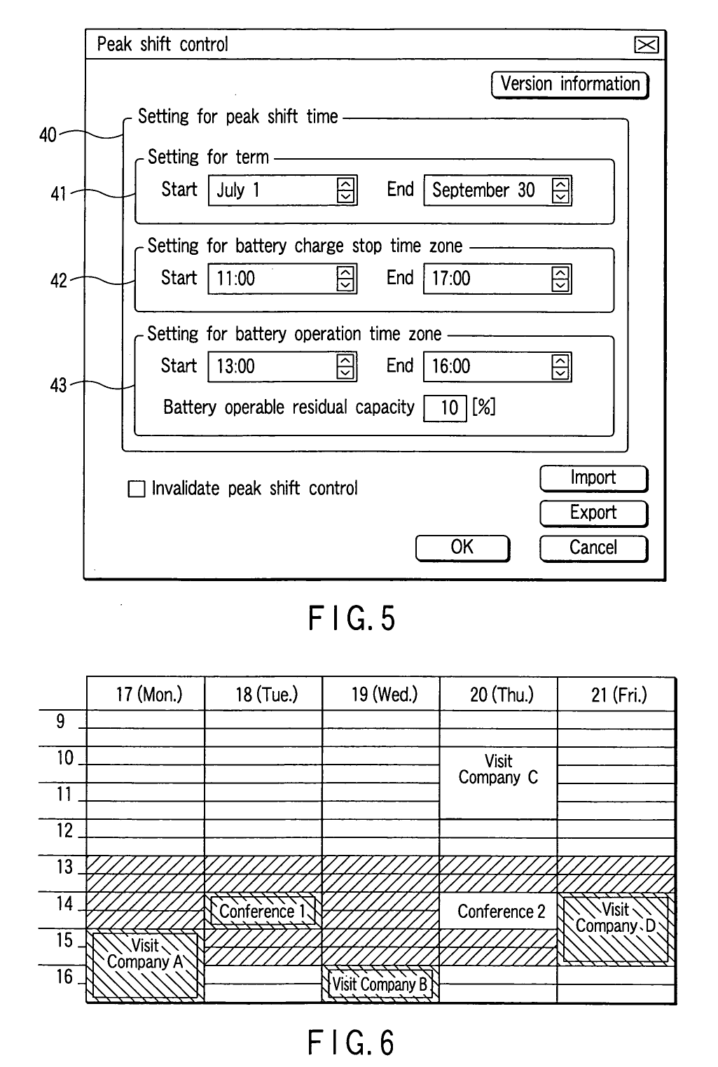

FIG. 6 is a view showing one example of the schedule note managed by the schedule management application 32 on the storage medium 17.

According to the example, the battery operation time zone (“AC power inhibit period”) is set to 13:00 p.m. to 16:00 p.m. The battery charge time spent for charging battery is set as 1.5 hours. (For convenience of explanation, battery charge time is fixed herein.) Various plans on the schedule note, that is, “visit company A”, “visit company B”, “visit company D” and “conference 1” are preset as the plan to use battery drive by the user.

In the foregoing case, when 13:00 p.m. comes everyday, the power supply source is automatically changed from AC power to battery according to the peak shift control. When 16:00 p.m. comes, the power supply source is automatically returned from battery to AC power.

1) On the 17th, battery drive is set from 13:00 p.m.; however, the plan “visit company A” is made at 15:00 p.m. For this reason, the power supply source changes from battery drive to AC power drive before 1.5 hours from that time, that is, at 13:30 p.m., and battery charge is started.

2) On the 18th, battery drive is set from 13:00 p.m.; however, the plan “conference 1” is made at 14:00. For this reason, battery charge is started using AC power before 1.5 hours from that time, that is, at 12:30 p.m. In this case, the power supply source is not changed to battery drive at 13:00 p.m.

3) On the 19th, battery drive is set from 13:00 p.m.; however, the plan “visit company B” is made at 16:00 p.m. For this reason, the power supply source changes from battery drive to AC power drive before 1.5 hours from that time, that is, at 14:30 p.m., and battery charge is started.

4) On the 20th, there is no plan to use the electronic apparatus by battery drive. The plan “conference 2” is made at 14:00 p.m.; however, the data is not applied to the plan of battery drive. Thus, battery drive is set from 13:00 p.m. according to normal peak shift control.

5) On the 21st, battery drive is set from 13:00 p.m.; however, the plan “visit company D” is made at 14:00 p.m. For this reason, the power supply source changes from battery drive to AC power drive before 1.5 hours from that time, that is, at 12:30 p.m., and battery charge is started using AC power. In this case, the power supply source is not changed to battery drive at 13:00 p.m.

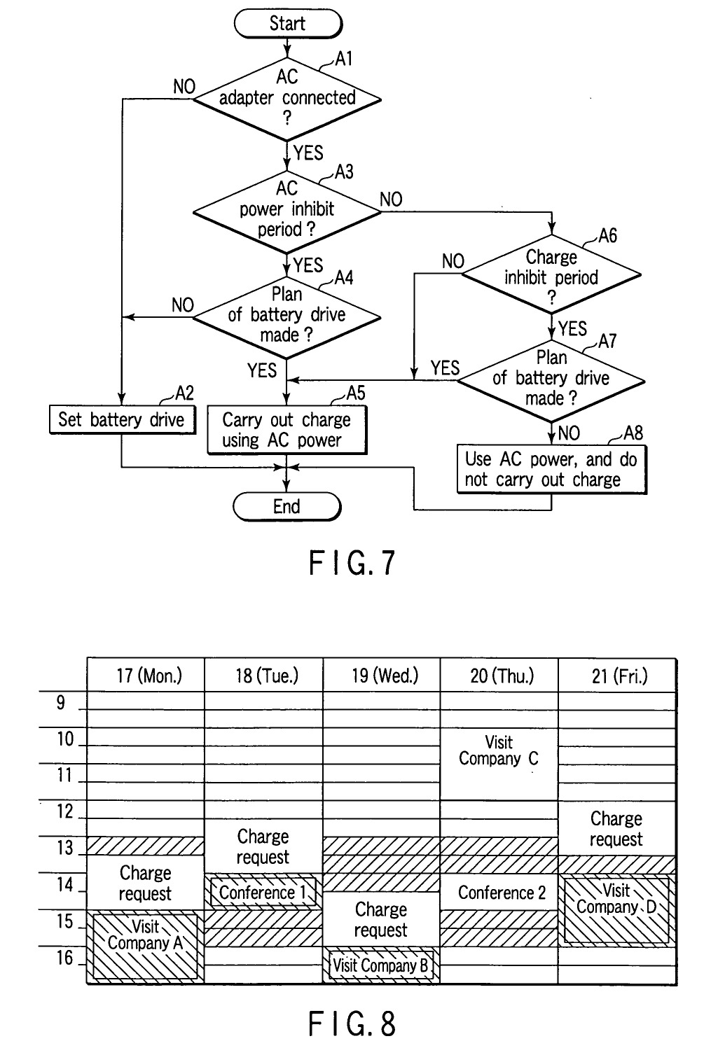

The power control based on the schedule note shown in FIG. 6 will be explained below with reference to FIG. 7.

First, it is determined whether or not the electronic apparatus is connected with an AC adapter (AC power) (step A1). If no connection is made, battery drive is set (step A2). On the other hand, if connection is made, it is determined whether or not the current time is equivalent to the “AC power inhibit period” (step A3).

If the current time is equivalent to the “AC power inhibit period”, it is determined whether or not battery drive is set (step A4). If no plan of battery drive is made, battery drive is set (step A2). On the other hand, if the plan of battery drive is made, charge is carried out using AC power even if the “AC power inhibit period” is given (step A5).

In step A3, if the “AC power inhibit period” is not given, it is determined whether or not the current time is equivalent to the “charge inhibit period” (step A6). If the “charge inhibit period” is not given, charge is carried out using AC power (step A5). On the other hand, if the “charge inhibit period” is given, it is determined whether or not there exists the plan of battery drive (step A7).

If there exists the plan of battery drive, charge is carried out using AC power even if the “charge inhibit period” is given (step A5). On the other hand, if there exists no plan of battery drive, the AC power is used; however, no charge is carried out (step A8).

FIG. 8 is a view showing a modification example of the schedule note shown in FIG. 6.

The schedule note of FIG. 8 registers a “charge request period” indicative of requesting battery charge on the schedule note of FIG. 6 in accordance with user's request. The “charge request period” is registered on time zone corresponding to the “battery charge time (1.5 hours)” described in FIG. 6.

In this case, the state determining section 31A detects the “charge request period” registered in the schedule note, thereby determining that there exists the plan to use the electronic apparatus by battery drive.

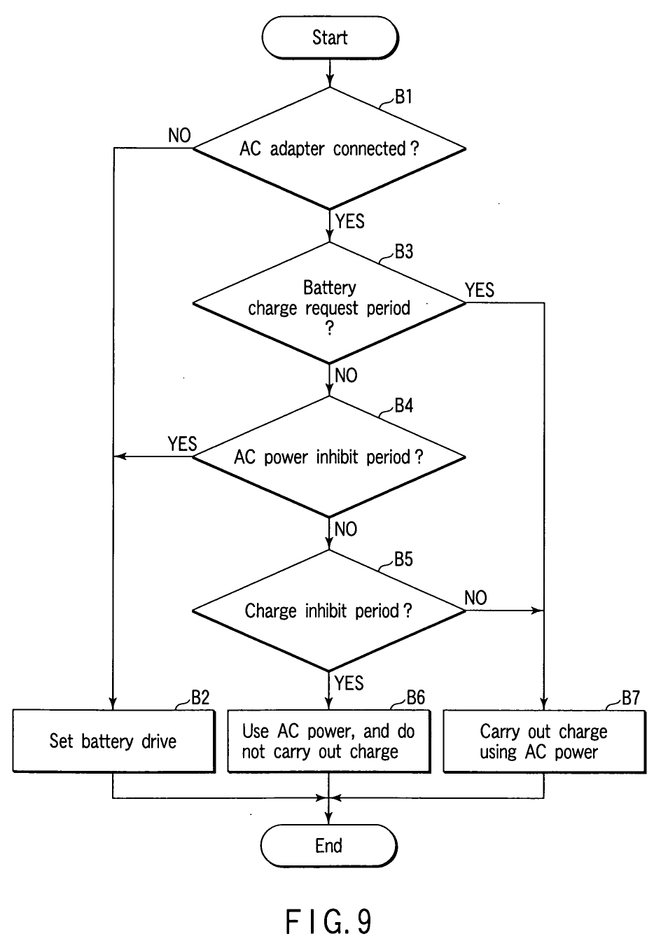

The power control based on the schedule note shown in FIG. 8 will be explained below with reference to FIG. 9.

First, it is determined whether or not the electronic apparatus is connected with an AC adapter (AC power) (step B1). If no connection is made, battery drive is set (step B2). On the other hand, if connection is made, it is determined whether or not the current time is equivalent to the battery “charge request period” (step B3). If the “charge request period” is not given, it is determined whether or not the current time is not equivalent to the “AC power inhibit period” (step B4).

If the “AC power inhibit period” is given, battery drive is set (step B2). On the other hand, if the “AC power inhibit period” is not given, it is determined whether or not the current time is not equivalent to the “charge inhibit period” (step B5).

If the “charge inhibit period” is given, the AC power is used; however, no charge is carried out (step B6).

In step B3, if the “charge request period” is given, charge is carried out using the AC power (step B7). In step B5, if the “charge inhibit period” is not given, charge is carried out using the AC power (step B7).

According to the embodiment, the user has no need to be conscious of starting charge after going back the fixed time from the time when the situation of using battery as power source occurs. This serves to dispense with user's work of interrupting peak shift control. Therefore, it is possible to remarkably reduce load on the user.

The embodiment has explained about the case where the electronic apparatus has the peak shift control. The configuration that the electronic apparatus has no peak shift control is given. In this case, when no AC adapter is connected, AC adapter connection guidance for battery charge may be displayed according to charge estimation, and charge may be effectively recommended.

According to the present invention, it is possible to drive the electronic apparatus with sufficient battery capacity when the situation of using battery as power source occurs without giving load to a user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus, comprising:
a power management section configured to make power management based on setting information on which at least an AC power inhibit period for inhibiting use of AC power is set;
a state determining section configured to determine whether there exists a plan to use the electronic apparatus by a battery drive when the electronic apparatus is connected with the AC power; and
a power control section configured to execute battery charge using the AC power even if a current time is equivalent to the AC power inhibit period set in the power management section when the state determining section determines that there exists a plan to use the electronic apparatus by the battery drive.

2. The apparatus according to claim 1, wherein:
the power management section makes power management based on setting information on which a charge inhibit period for inhibiting battery charge is set, and
the power control section executes battery charge using the AC power even if a current time is equivalent to the charge inhibit period set in the power management section when the state determining section determines that there exists a plan to use the electronic apparatus by the battery drive.

3. The apparatus according to claim 1, wherein the state determining section calculates a charge time spent for charge from the maximum battery capacity and the battery capacity at a current time, and determines whether or not there exists a start point of a plan to use the electronic apparatus by the battery drive until the charge time elapses from the current time.

4. The apparatus according to claim 1, further comprising a schedule management section configured to register a period having a plan to use the electronic apparatus by the battery drive to a schedule note together with the AC power inhibit period,
wherein the state determining section makes the determination based on the schedule note managed by the schedule management section.

5. The apparatus according to claim 4, wherein:
the schedule management section registers a charge request period for requesting battery charge to the schedule note, and
the state determining section detects the charge request period registered to the schedule note managed by the schedule management section.

6. A power control method applied to an electronic apparatus, comprising:
making power management based on setting information on which at least an AC power inhibit period for inhibiting use of AC power is set;
determining whether there exists a plan to use the electronic apparatus by a battery drive when the electronic apparatus is connected with the AC power; and
executing battery charge using the AC power even if a current time is equivalent to the AC power inhibit period set in the power management when the determination indicates that there exists a plan to use the electronic apparatus by the battery drive.

7. The method according to claim 6, wherein:
the power management is made based on setting information on which a charge inhibit period for inhibiting battery charge is set, and
the battery charge is executed using the AC power even if a current time is equivalent to the charge inhibit period set in the power management when the determination indicates that there exists a plan to use the electronic apparatus by the battery drive.

8. The method according to claim 6, wherein the determination includes calculating a charge time spent for charge from the maximum battery capacity and the battery capacity at a current time, and determining whether or not there exists a start point of a plan to use the electronic apparatus by the battery drive until the charge time elapses from the current time.

9. The method according to claim 6, further comprising registering a period having a plan to use the electronic apparatus by the battery drive to a schedule note together with the AC power inhibit period,
wherein the determination is made based on the schedule note.

10. The method according to claim 9, further comprising:
registering a charge request period for requesting battery charge to the schedule note; and
detecting the charge request period registered to the schedule note managed by the schedule management section.
